(19) United States
(12) Patent Application Publication
(10) Pub. No.: US 2013/0290990 A1
(43) Pub. Date: Oct. 31, 2013

(54) CASING STRUCTURE OF SLIM OPTICAL DISK DRIVE

(71) Applicant: QUANTA STORAGE INC., Taoyuan County (TW)

(72) Inventors: Yao-Ting KUO, Taoyuan County (TW); Jen-Chen WU, Taoyuan County (TW)

(73) Assignee: QUANTA STORAGE INC., Taoyuan County (TW)

(21) Appl. No.: 13/688,385

(22) Filed: Nov. 29, 2012

(30) Foreign Application Priority Data
Apr. 27, 2012 (CN) 201210128808.9

(51) Int. Cl. G11B 33/08

(52) U.S. Cl. CPC G11B 33/08
USPC 720/651

(57) ABSTRACT

A casing structure of a slim optical disk drive is provided. The casing is formed by an upper casing and a lower casing. A notch is formed on the upper casing or the lower casing. The notch can receive a tag. The depth of the notch is larger than or equal to the thickness of the tag. The tag adhered to the notch does not cross over the notch and jut out from the casing, so that the gap is avoided and the noise is reduced.

This application claims the benefit of People's Republic of China application Serial No. 201210128808.9, filed Apr. 27, 2012, the subject matter of which is incorporated herein by reference.

### BACKGROUND OF THE INVENTION

1. Field of the Invention

The invention relates in general to a slim optical disk drive, and more particularly to a casing structure of a slim optical disk drive for receiving a tag adhered to the casing.

2. Description of the Related Art

As the notebook computer is getting thinner and thinner, the thickness of a optical disk drive which acts as a main element of the notebook computer must be further reduced, so that the optical disk drive can be assembled to the notebook computer whose internal space is getting narrower and narrower, and the portability and storage of the notebook computer are made easier and more convenient.

FIG. 1 is a schematic diagram of a slim optical disk drive according to the prior art being assembled to a notebook computer. As indicated in the slim optical disk drive 10, a hollowed casing is formed by an upper casing 11a and a lower casing 11b. A tray 12, received in the casing, can freely slide into/out of the casing. The tray 12 carries a spindle motor 13 for rotating an optical disk 14 at a high speed. A pick-up head (not illustrated) moves along a radial direction of the optical disk 14 to access the data of the optical disk 14 and then transmits the data to a motherboard 16 disposed at the rear end of the slim optical disk drive 10 through a wire 15 connected to the tray 12. The motherboard 16 processes the received data and then outputs the processed data to a notebook computer 17. A metal protection board 18 covers a lower portion of the tray 12 lest the precision electronic components moved outside the casing with the tray 13 might be interfered with or damaged by an electromagnetic wave. A tag 19, containing information such as safety specification, product model, and manufacturer details, is pasted on the upper casing 11a of the slim optical disk drive 10. When the slim optical disk drive 10 is disposed in the ultra-slim notebook computer 17, the slim optical disk drive 10 is tightly pressed on both the top and the bottom of the casing or internal elements of the notebook computer 17 and the thickness of the notebook computer 17 is thus reduced.

However, though the tag 19 is thin like a thin paper, a gap G is still generated when the tag 19 separates the notebook computer 17 from the casing of the slim optical disk drive 10. When the slim optical disk drive 10 rotates the optical disk 14 or moves the pick-up head at a high speed, the resulted vibration will cause the casing of the slim optical disk drive 10 to collide with the notebook computer 17 and make noise accordingly. Similarly, when the notebook computer 17 vibrates, the notebook computer 17 also collides the casing of the slim optical disk drive 10 and make noise. Moreover the thickness of the tag increases the overall height of the slim optical disk drive. Therefore, when it comes to the casing structure, the slim optical disk drive of the prior art still has many problems to resolve.

### SUMMARY OF THE INVENTION

According to an embodiment of the present invention, a casing structure of a slim optical disk drive is provided. A notch is formed on the slim optical disk drive of the casing by way of stamping for receiving a tag, and the height of the slim optical disk drive can thus be reduced.

According to another embodiment of the present invention, a casing structure of a slim optical disk drive is provided. Since the depth of the notch formed on the slim optical disk drive of the casing is larger than or equal to the thickness of a tag, the gap between the slim optical disk drive and the notebook computer is avoided, and the noise is reduced.

According to an alternate embodiment of the present invention, a casing structure of a slim optical disk drive is provided. The casing is formed by an upper casing and a lower casing. A notch is formed on the upper casing or the lower casing. The notch can receive a tag. The depth of the notch is larger than or equal to the thickness of the tag. The tag adhered to the notch does not cross over the notch and jut out from the casing, and the overall height of the slim optical disk drive is not increased.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1 is a schematic diagram of a slim optical disk drive according to the prior art being assembled to a notebook computer;

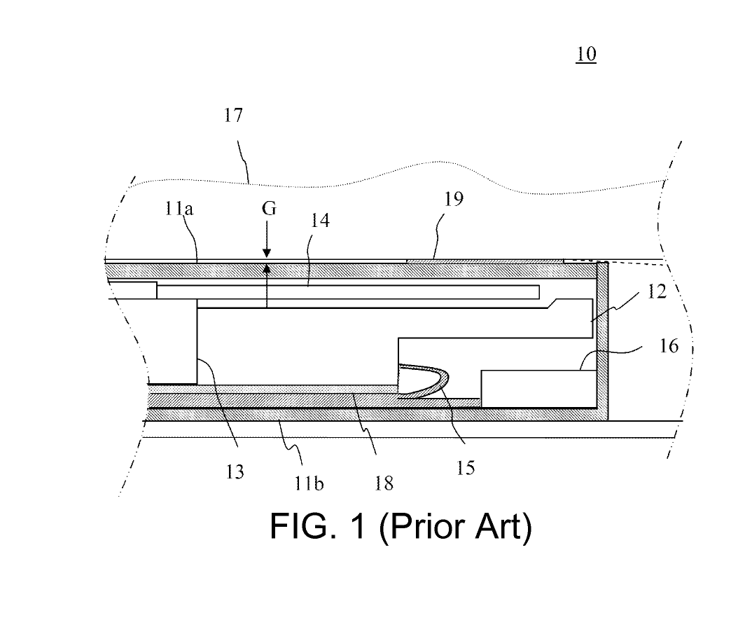

FIG. 2 is a 3D rear view of a casing structure of a slim optical disk drive according to a first embodiment of the invention;

FIG. 3 is a partial cross-sectional view of a slim optical disk drive according to a first embodiment of the invention being disposed on a notebook computer;

FIG. 4 is a partial cross-sectional view of a slim optical disk drive according to a second embodiment of the invention being disposed on a notebook computer.

### DETAILED DESCRIPTION OF THE INVENTION

The technologies used in the invention and the effects are disclosed below in a number of exemplary embodiments with accompanying drawings.

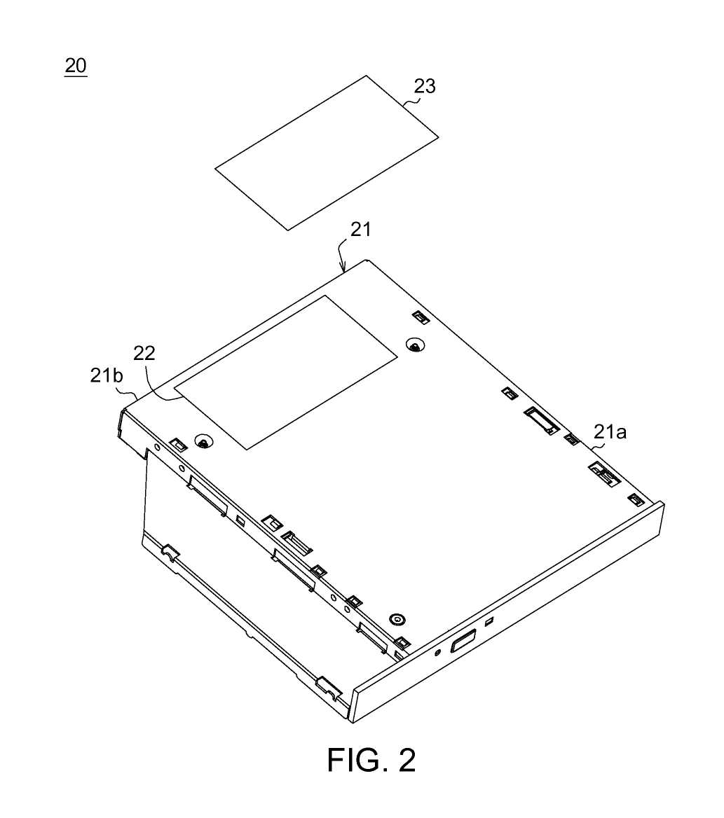

Referring to FIG. 2, a 3D rear view of a casing structure 21 of a slim optical disk drive 20 according to a first embodiment of the invention is shown. The casing 21 of the slim optical disk drive 20 is formed by an upper casing 21a and a lower casing 21b. A notch 22 is formed on the lower casing 21b by way of stamping. The notch 22 can receive a tag 23. Although the shape of the notch 22 is exemplified by a rectangle in the first embodiment, the notch 22 is not limited to a rectangular notch 22. The depth of the notch 22 is larger than or equal to the thickness of the tag 23. The tag 23 is adhered to the notch 22.

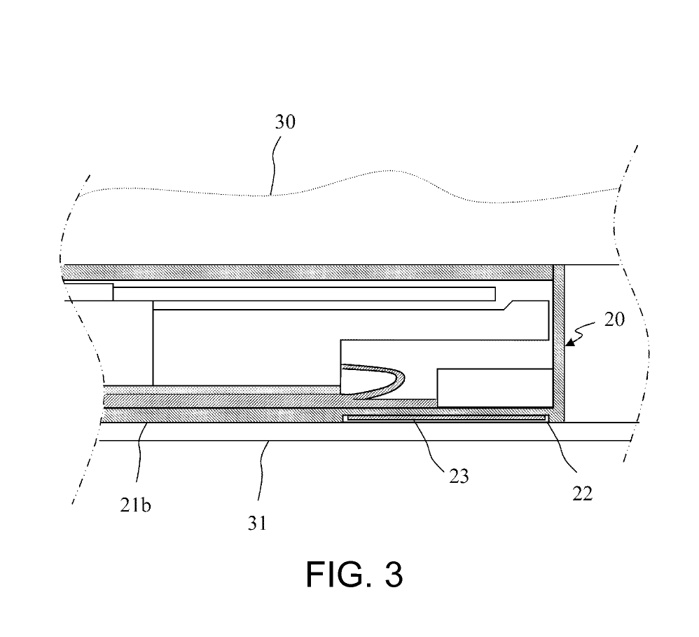

Referring to FIG. 3, a partial cross-sectional view of a slim optical disk drive 20 being disposed on a notebook computer 30 according to a first embodiment of the invention is shown. The depth of the notch 22 is larger than or equal to the thickness of the tag 23. When the tag 23 is adhered to the notch 22, the tag 23 is received in the notch 22 and does not cross over the notch 22 and jut out from lower casing 21b. When the slim optical disk drive 20 is disposed on the notebook computer 30, the casing 31 of the notebook computer 30 tightly presses the lower casing 21b of the slim optical disk drive 20, and the tag 23 received in the notch 22 does not generate a gap between the lower casing 21b of the slim optical disk drive 20 and the casing 31 of the notebook computer 30. The overall height of the slim optical disk drive 20 is not increased. Instead, the overall height of the notebook computer 30 is reduced, and the lower casing 21b of the slim optical disk drive 20 tightly presses the casing 31 of the notebook computer 30. When the slim optical disk drive 20 or the notebook computer 30 operates, the casing of the slim optical disk drive 20 will not collide with the notebook computer 30 and make noise.

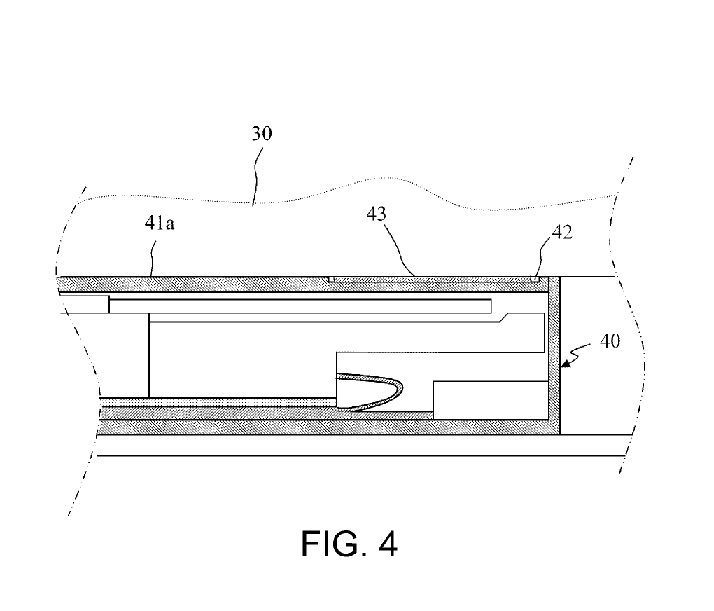

Referring to FIG. 4, a partial cross-sectional view of a slim optical disk drive 40 being disposed on a notebook computer according to a second embodiment of the invention is shown. In the casing of the slim optical disk drive 40, a notch 42a is formed in an upper casing 41 by way of stamping. The depth of the notch 42 is larger than or equal to the thickness of a tag 43. When the tag 43 is adhered to the notch 42, the tag 43 is received in the notch 42 and will not cross over the notch 42 and jut out from upper casing 41a. Since the casing of the slim optical disk drive 40 tightly presses the inside of the notebook computer 30, no gap is generated between the casing of the slim optical disk drive 40 and the notebook computer 30 and the overall height of the notebook computer is reduced. When the slim optical disk drive 40 or the notebook computer 30 operates, the slim optical disk drive 40 will not collide with the notebook computer 30 and make noise.

According to the casing structure of the slim optical disk drive disclosed in the above embodiments of the invention, a notch is formed on the casing of the slim optical disk drive by way of stamping. The depth of the notch is larger than or equal to the thickness of the tag, so that the tag can be adhered to and received in the notch to avoid a gap being generated between the slim optical disk drive and the notebook computer. Therefore, the slim optical disk drive or the notebook computer operates, the slim optical disk drive will not collide with the notebook computer and make noise, and the overall height of the notebook computer can further be reduced.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A casing structure of a slim optical disk drive, wherein the casing structure comprises a casing, a notch is formed on the casing, the notch can receive a tag, the depth of the notch is larger than or equal to the thickness of the tag, and the tag adhered to the notch does not cross over the notch and jut out from the casing.

2. The casing structure of a slim optical disk drive according to claim 1, wherein the casing is formed by an upper casing and a lower casing.

3. The casing structure of a slim optical disk drive according to claim 2, wherein the notch is formed on the upper casing.

4. The casing structure of a slim optical disk drive according to claim 2, wherein the notch is formed on the lower casing.

5. The casing structure of a slim optical disk drive according to claim 1, wherein the notch is a rectangle.
